(19) United States
(12) Patent Application Publication
(10) Pub. No.: US 2015/0191265 A1
(43) Pub. Date: Jul. 9, 2015

(54) METHOD OF PACKING GLASS SUBSTRATES

(71) Applicant: Corning Precision Materials Co., Ltd., Chungcheongnam-do (KR)

(72) Inventors: Kyu-Hwan Lee, Chungcheongnam-do (KR); Kyung Chul Lee, Chungcheongnam-do (KR); BumRo Lee, Chungcheongnam-do (KR)

(73) Assignee: Corning Precision Materials Co., Ltd., Chungcheongnam-do (KR)

(21) Appl. No.: 14/592,261

(22) Filed: Jan. 8, 2015

(30) Foreign Application Priority Data
Jan. 9, 2014 (KR) 10-2014-0002846

(51) Int. Cl. B65B 23/20; B29C 51/00

(52) U.S. Cl. CPC B65B 23/20; B29C 51/002; B29K 2023/04; B29L 2031/7162

(57) ABSTRACT

A glass substrate protection pad and a method of manufacturing a large glass substrate protection pad able to prevent a glass substrate from being damaged. The glass substrate protection pad is to be in close contact with a glass substrate to protect the glass substrate. The glass substrate protection pad is formed of expanded polypropylene (EPP).

### CROSS REFERENCE TO RELATED APPLICATION

The present application claims priority from Korean Patent Application Number 10-2014-0002846 filed on Jan. 9, 2014, the entire contents of which are incorporated herein for all purposes by this reference.

### BACKGROUND OF THE INVENTION

1. Field of the Invention

The present invention relates to a method of packing glass substrates, and more particularly, to a method of packing glass substrates able to prevent the glass substrates from being damaged.

2. Description of Related Art

A packing container is used as a means for packing a plurality of glass substrates used in display panels or the like. For example, glass substrate manufacturers supply a plurality of manufactured glass plates to display panel manufacturers by packing the glass plates in a packing container. Such a glass substrate packing container contains, for example, 100 to 500 glass substrates with paper sheets and/or films alternating with the glass substrates. In this case, glass substrate protection pads are disposed on the front surface and the rear surface of the stack of the 100 to 500 glass substrates in order to protect the glass substrates.

FIG. 1 is an exploded perspective view illustrating a glass substrate protection pad of the related art. As illustrated in FIG. 1, the glass substrate protection pad 10 of the related art includes ethylene vinyl acetate (EVA) pads 11, 13 and 16, aluminum (Al) pads 12 and 15 and rubber pads 14.

The front or rear EVA pad 11 or 16 comes into close contact with a corresponding glass substrate, and the Al pads 12 and 15 function to prevent the glass substrate protection pad 10 from warping. The rubber pads 14 fitted into through-holes 13a in the inner EVA pad 13 prevent the corresponding glass substrate from being damaged by the corners of the glass substrate protection pad 10.

However, this glass substrate protection pad of the related art has the drawbacks of a complicated structure and expensive manufacturing costs. In addition, the adhesion force between an inner material and an outer material at an edge portion or a corner portion is not strong. When the glass substrate protection pad is reused, the edge portion or the corner portion becomes loose or is torn, as illustrated in FIG. 2, which is problematic.

The information disclosed in the Background of the Invention section is provided only for better understanding of the background of the invention and should not be taken as an acknowledgment or any form of suggestion that this information forms a prior art that would already be known to a person skilled in the art.

### RELATED ART DOCUMENT

Patent Document 1: Japanese Unexamined Patent Publication No. 2012-532806 (Aug. 9, 2012)

### BRIEF SUMMARY OF THE INVENTION

Various aspects of the present invention provide a glass substrate protection pad able to simplify the structure and reduce the manufacturing cost. Also provided is a method of manufacturing a large glass substrate protection pad able to facilitate the manufacture of a large glass substrate protection pad.

In an aspect of the present invention, provided is a glass substrate protection pad in close contact with a glass substrate to protect the glass substrate, the glass substrate protection pad comprising expanded polypropylene (EPP).

In the glass substrate protection pad, four edge surfaces may be rounded convexly.

In the glass substrate protection pad, a surface to be in close contact with the glass substrate may be embossed.

The embossed surface may have a striped pattern or a dotted pattern.

In an aspect of the present invention, provided is a method of manufacturing a large glass substrate protection pad by bonding two glass substrate protection sub-pads formed of expanded polypropylene (EPP). The method including: preparing and disposing the two glass substrate protection sub-pads such that surfaces of the two glass substrate protection sub-pads to be bonded face each other at a predetermined distance; and bonding the two glass substrate protection sub-pads together.

The process of bonding the two glass substrate protection sub-pads may include disposing expanded polypropylene (EPP) in a space between the surfaces of the two glass substrate protection sub-pads to be bonded, followed by thermoforming.

The surfaces of the two glass substrate protection sub-pads to be bonded may have steps which have opposite convexo-concave shapes to each other

The process of bonding the two glass substrate protection sub-pads together may include disposing expanded polypropylene (EPP) in the space between the surfaces of the two glass substrate protection sub-pads to be bonded by injecting polypropylene and steam into the space between the surfaces of the two glass substrate protection sub-pads to be bonded.

The thermoforming may be carried out in a temperature ranging from 100 to 150° C.

In each of the two glass substrate protection sub-pads to be bonded, three edge surfaces except for the surface to be bonded are rounded convexly.

In each of the two glass substrate protection sub-pads to be bonded, a surface to be in close contact with a glass substrate may be embossed. The embossed surface may have a striped pattern or a dotted pattern.

In an aspect of the present invention, provided is a method of packing glass substrates, the method comprising preparing glass substrate protection pads; and packing the plurality of glass substrates into a packing container such that the glass substrate protection pads are interposed between the plurality of glass substrates respectively.

According to the present invention, the glass substrate protection pad has a single layer structure, making it possible to reduce the manufacturing time and cost thereof.

In addition, according to the present invention, it is possible to reduce the repairing and replacement cost caused by the damages of the glass substrate protection pad.

Furthermore, according to the present invention, it is possible to improve the efficiency of the operation of packing or unpacking glass substrates.

In addition, according to the present invention, it is possible to easily manufacture a large glass substrate protection pad.

The methods and apparatuses of the present invention have other features and advantages that will be apparent from or are set forth in greater detail in the accompanying drawings which are incorporated herein, and in the following Detailed Description of the Invention, which together serve to explain certain principles of the present invention.

### BRIEF DESCRIPTION OF THE DRAWINGS

FIG. 1 is an exploded perspective view illustrating a glass substrate protection pad of the related art;

FIG. 2 illustrates pictures of damaged glass substrate protection pads of the related art;

FIG. 3 is a perspective view illustrating an exemplary embodiment of a glass substrate protection pad according to the present invention;

FIG. 4 is a schematic flowchart illustrating an exemplary embodiment of a method of manufacturing a large glass substrate protection pad according to the present invention; and

FIG. 5 shows parts of the two glass substrate protection sub-pads to be bonded which each have steps.

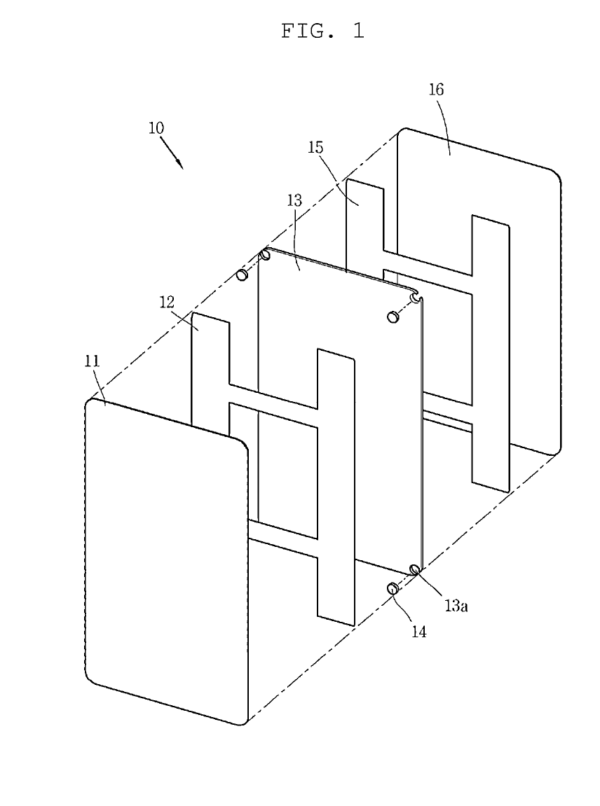

### DETAILED DESCRIPTION OF THE INVENTION

Reference will now be made in detail to a glass substrate protection pad and a method of manufacturing a large glass substrate protection pad according to the present invention in conjunction with the accompanying drawings so that a person skilled in the art to which the present invention relates could easily put the present invention into practice.

Throughout this document, reference should be made to the drawings, in which the same reference numerals and symbols are used throughout the different drawings to designate the same or similar components. In the following description of the present invention, detailed descriptions of known functions and components incorporated herein will be omitted in the case that the subject matter of the present invention is rendered unclear.

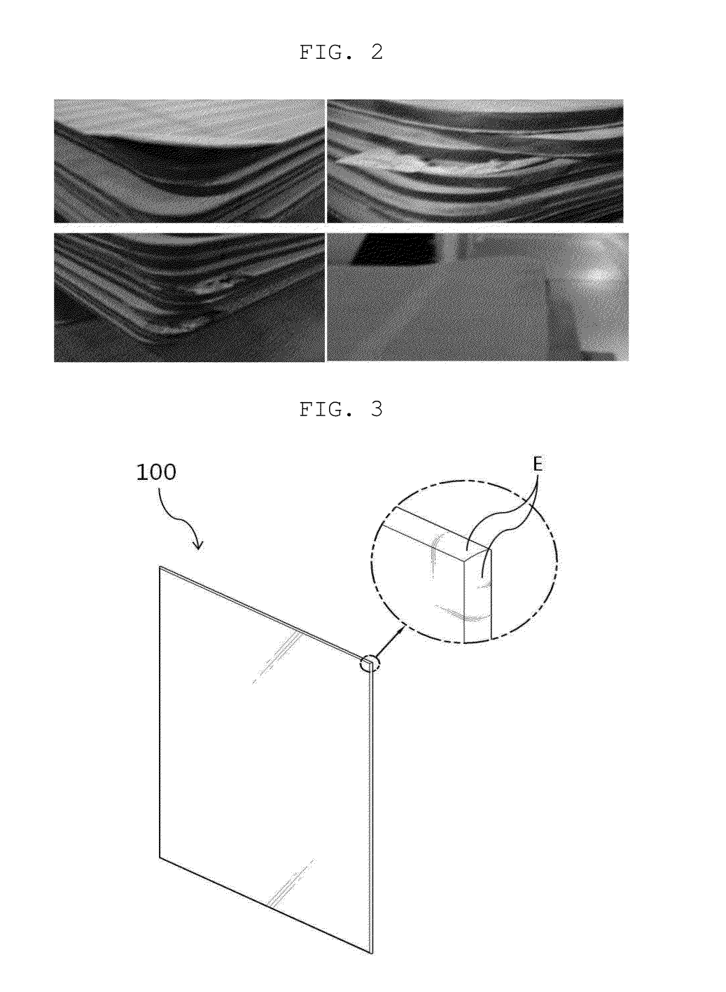

FIG. 3 is a perspective view illustrating an exemplary embodiment of a glass substrate protection pad according to the present invention.

As illustrated in FIG. 3, the glass substrate protection pad 100 is in close contact with the front surface of a glass substrate to protect the glass substrate, and is formed of expanded polypropylene (EPP).

Expanded polypropylene (EPP) has increased stiffness and shock-absorbing ability than ethylene vinyl acetate (EVA). Even in the case in which the glass substrate protection pad 100 is formed of expanded polypropylene (EPP) alone, both a glass substrate protection function and the ease of glass substrate packing and/or unpacking works can be obtained.

In the related art, a glass substrate protection pad having a multilayer structure in which an aluminum (Al) thin film, an elastic member and the like are stacked on an EVA pad in order to reinforce the poor stiffness and shock-absorbing ability of the EVA pad. In contrast, according to the present invention, it is possible to manufacture the glass substrate protection pad 100 having a single layer structure from expanded polypropylene (EPP).

Accordingly, it is possible to eliminate the problem of the related art in which the glass substrate protection pad having the multilayer structure is discarded since the edge portion or the corner portion thereof is loose or torn. It is also possible to reduce the manufacturing cost of the glass substrate protection pad 100.

Since the glass substrate protection pad 100 has a single layer structure formed of expanded polypropylene (EPP), the glass substrate protection pad 100 can be made lighter. It is therefore easier for workers to pack or unpack glass substrates.

It is preferable that the four edge surfaces E of the glass substrate protection pad 100 may be rounded to be convex.

Since the four edge surfaces E of the glass substrate protection pad 100 are rounded to be convex, it is possible to prevent the edges of the glass substrate protection pad 100 from damaging a glass substrate. That is, the glass substrate protection pad must have a predetermined level of stiffness for the ease of the operation of bringing the glass substrate protection pad into close contact with a glass substrate. When the four edge surfaces of the stiff glass substrate protection pad are perpendicular to the main plane of the glass substrate protection pad, a glass substrate may be damaged when the edges of the glass substrate protection pad come into contact with the glass substrate.

In addition, in the glass substrate protection pad 100 according to an exemplary embodiment of the present invention, the surface to be in close contact with a glass substrate may be embossed.

Since the surface to be in close contact with a glass substrate is embossed, it is possible to prevent a film, a paper sheet or a glass substrate from clinging to the glass substrate protection pad 100 due to surface pressure when detaching the glass substrate protection pad 100 from the glass substrate.

The embossed surface may have a variety of patterns, such as a striped pattern or a dotted pattern.

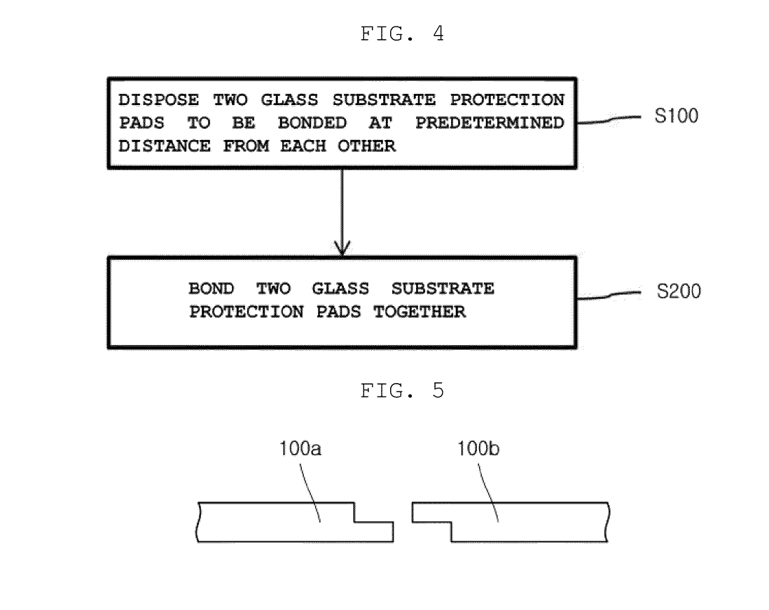

FIG. 4 is a schematic flowchart illustrating an exemplary embodiment of a method of manufacturing a large glass substrate protection pad according to the present invention.

As illustrated in FIG. 4, the method of manufacturing a large glass substrate protection pad may include a preparation step S100 of preparing glass substrate protection sub-pads 100a, 100b to be bonded and a bonding step S200 of bonding the prepared glass substrate protection sub-pads 100a, 100b together.

In order to manufacture a large glass substrate protection pad by boding the two glass substrate protection sub-pads 100a, 100b formed of expanded polypropylene (EPP), at S100, the two glass substrate protection sub-pads 100a, 100b are disposed such that the surfaces of the two glass substrate protection sub-pads 100a, 100b to be bonded face each other at a predetermined distance. Each of the surfaces to be bonded is one of the four edge surfaces of the glass substrate protection sub-pads 100a, 100b.

It is preferable that the surfaces of the two glass substrate protection sub-pads 100a, 100b to be bonded have steps which have opposite convexo-concave shapes to each other. For example, as shown in FIG. 5, a part of one of the glass substrate protection sub-pads 100a, 100b to be bonded has an “ [symbol] ” shaped cross-section, and that a part of the other one of the glass substrate protection sub-pads 100a, 100b to be bonded has a “ [symbol] ” shaped cross-section. Since the parts to be bonded have these shapes, it is possible to increase the bonding areas, thereby improving adhesion force. However, this shape of the parts to be bonded is not intended to be limiting.

Afterwards, at S200, the two glass substrate protection sub-pads 100a, 100b are bonded together, thereby completing the manufacture of a large glass substrate protection pad.

The two glass substrate protection sub-pads 100a, 100b may be bonded together by a variety of methods, for example, using an adhesive.

Preferably, it is possible to manufacture a large glass substrate protection pad by bonding the two glass substrate protection sub-pads 100a, 100b together by injecting expanded polypropylene (EPP) into the space therebetween.

In this manner, it is possible to bond the two glass substrate protection sub-pads 100a, 100b together by thermoforming using the same material, expanded polypropylene (EPP), without using an adhesive, thereby increasing the adhesion force between the bonded glass substrate protection sub-pads 100a, 100b. It is also possible to prevent a glass substrate from being contaminated by impurities originating from the adhesive.

Here, the injection of expanded polypropylene (EPP) may be completed by injecting polypropylene (PP) and steam into the space between the surfaces of the two glass substrate protection sub-pads 100a, 100b to be bonded. The injected steam may be exhausted through the other side opposite the side through which the expanded polypropylene (EPP) is injected.

It is preferable that the thermoforming is carried out in a temperature ranging from 100 to 150° C.

Each of the two glass substrate protection sub-pads 100a, 100b to be bonded may be a glass substrate protection pad, of which the three edge surfaces except for the edge surface to be bonded are rounded convexly. Since the glass substrate protection sub-pads 100a, 100b, of which the three edge surfaces except for the edge surface to be bonded are rounded convexly, are bonded together, it is possible to manufacture a large glass substrate protection pad, of which the four edge surfaces are rounded convexly.

In addition, in the two glass substrate protection sub-pads 100a, 100b to be bonded together, the surfaces to be in close contact with a glass substrate may be embossed. The embossed surfaces may have a variety of patterns, such as a striped pattern or a dotted pattern.

The foregoing descriptions of specific exemplary embodiments of the present invention have been presented with respect to the drawings. They are not intended to be exhaustive or to limit the present invention to the precise forms disclosed, and obviously many modifications and variations are possible for a person having ordinary skill in the art in light of the above teachings.

It is intended therefore that the scope of the present invention not be limited to the foregoing embodiments, but be defined by the Claims appended hereto and their equivalents.

What is claimed is:

1. A method of packing a plurality of glass substrates, the method comprising:
preparing glass substrate protection pads; and
packing the plurality of glass substrates into a packing container with the glass substrate protection pads interposed between the plurality of glass substrates respectively,
the glass substrate protection pad comprising expanded polypropylene.

2. The method according to claim 1, wherein each glass substrate protection pad comprises four edge surfaces rounded convexly.

3. The method according to claim 1, wherein a surface of the glass substrate protection pad to be in close contact with the glass substrate is embossed.

4. The method according to claim 3, wherein the surface is embossed in a striped pattern or a dotted pattern.

5. The method according to claim 1,
wherein preparing the glass substrate protection pads comprises:
disposing two glass substrate protection sub-pads such that edge surfaces of the two glass substrate protection sub-pads to be bonded face each other at a predetermined distance from each other; and
bonding the two glass substrate protection sub-pads together.

6. The method according to claim 5, wherein the edge surfaces of the two glass substrate protection sub-pads to be bonded have steps which have opposite convexo-concave shapes to each other.

7. The method according to claim 5, wherein bonding the two glass substrate protection sub-pads comprises disposing expanded polypropylene in a space between the edge surfaces of the two glass substrate protection sub-pads to be bonded, followed by thermoforming.

8. The method according to claim 7, wherein bonding the two glass substrate protection sub-pads together comprises injecting polypropylene and steam into the space between the edge surfaces of the two glass substrate protection sub-pads to be bonded.

9. The method according to claim 7, wherein the thermoforming is carried out in a temperature ranging from 100 to 150° C.

10. The method according to claim 5, wherein, in each of the two glass substrate protection sub-pads to be bonded, three edge surfaces except for the edge surface to be bonded are rounded convexly.
